(19) United States
(12) Patent Application Publication
(10) Pub. No.: US 2014/0135448 A1
(43) Pub. Date: May 15, 2014

(54) OLIGO- AND POLYIMIDES

(71) Applicants: Daniel Rome, Lund (SE); Jan-Erik Rosenberg, Falkenberg (SE); Erik Lager, Lund (SE); David Persson, Malmo (SE); Malin Knutsson, Ystad (SE); Dane Momcilovic, Lund (SE); Robert A. Gray, Blue Ash, OH (US); James R. Magato, Blue Ash, OH (US)

(72) Inventors: Daniel Rome, Lund (SE); Jan-Erik Rosenberg, Falkenberg (SE); Erik Lager, Lund (SE); David Persson, Malmo (SE); Malin Knutsson, Ystad (SE); Dane Momcilovic, Lund (SE); Robert A. Gray, Blue Ash, OH (US); James R. Magato, Blue Ash, OH (US)

(73) Assignees: MAVERICK CORPORATION, Blue Ash, OH (US); NEXAM CHEMICAL AB, Lund (SE)

(21) Appl. No.: 14/006,774

(22) PCT Filed: Mar. 30, 2012
(86) PCT No.: PCT/EP12/55860

§ 371 Date: Jan. 23, 2014

Related U.S. Application Data
(60) Provisional application No. 61/470,518, filed on Apr. 1, 2011.

(51) Int. Cl. C08G 73/10; C09D 179/08

(52) U.S. Cl. CPC C08G 73/1071; C09D 179/08
USPC 524/600; 525/436; 548/462

(57) ABSTRACT

An oligo- or polyimide comprising one or two residue(s) of an anhydride based acetylenic end-capper, at least one EBPA residue, at least one residue of anaromatic di-amine, and optionally at least one residue of an aromatic non-acetylenic di-anhydride is disclosed. A method for obtaining such an oligo- or polyimide is also disclosed.

### FIELD OF THE INVENTION

The present invention relates to novel cross-linkable oligo- and polyimides, comprising carbon-carbon triple bonds. It also relates to a method of obtaining such novel cross-linkable oligo- or polyimides.

### BACKGROUND

Polymers have for long been used as replacement materials for other materials, such as metals. They have the advantage of being light-weight material, which are relative easy to shape. However, polymers do typically have lower mechanical strength compared to metals. Further, they are less heat resistant.

The need for polymers with improved mechanical strength and heat resistance led to the development of aromatic polyimides. Aromatic polyimides are typically synthesized by condensation of aromatic carboxylic acid dianhydride monomers, such as pyromellitic dianhydride, 4,4′-oxydiphthalic anhydride, 2,2-bis-[4-(3,4-dicarboxyphenoxy)phenyl]-propane dianhydride, 3,3′,4,4′-benzophenonetetracarboxylic acid dianhydride or 3,3′,4,4′-tetracarboxybiphenyl dianhydride, with aromatic diamine monomers, such as 4,4′-oxydianiline, 1,4-diaminobenzene, 1,3-diaminobenzene, 1,3-bis-(4-aminophenoxy)benzene, 1,3-bis-(3-aminophenoxy)benzene, methylenedianiline or 3,4′-oxydianiline.

Polyimides obtained via condensation of pyromellitic dianhydride and 4,4′-oxydianiline are among others sold under the trademarks Vespel® and Meldin®. They constitute materials which are lightweight and flexible, and which have good resistant to heat and chemicals.

Further, thermoset polyimides have inherent good properties, such as wear and friction properties, good electrical properties, radiation resistance, good cryogenic temperature stability and good flame retardant properties. Therefore, they are used in the electronics industry for flexible cables, as an insulating film on magnet wire and for medical tubing. Polyimide materials are also used in high or low temperature exposed applications as structural parts were the good temperature properties is a prerequisite for the function.

The need to improve the processability, while improving, changing, or keeping the mechanical properties, of polyimides for use in airplanes and aerospace applications led to the introduction of cross-linking technologies. As the polymer chains are cross-linked, they may be shorter whilst the mechanical properties are maintained or even improved. Shorter polymer chains have the advantage of being easier to process, as the viscosity of the polymer melt is lower.

Examples of such cross-linking technologies include the bismaleimides and the nadimide-based PMR resins, which undergo cure at temperatures near 250° C. However, such thermoset polyimides will not withstand oxidative degradation on long-term exposure at temperatures above 200° C., as the crosslinking moieties have inferior thermal stability, compared to the oligoimide units.

In attempts to improve the thermal stability, thermoset polyimides containing phenylethynyl-substituted aromatic species as the reactive moieties have been developed.

U.S. Pat. No. 5,567,800 discloses phenylethynyl terminated imide oligomers (PETIs). Such oligomers may be prepared by firstly preparing amino terminated amic acid oligomers from dianhydride(s) and a slight excess of diamine(s) and subsequently end-cap the resulting amino terminated amic acid oligomers with phenylethynyl phtalic anhydride (PEPA). The amic acid oligomers are subsequently dehydrated to the corresponding imide oligomers.

Upon heating the triple bonds will react and cross-link the end-capped polyimid, thereby further improving its heat resistance and mechanical strength. As disclosed by U.S. Pat. No. 5,567,800 heating to at least 350° C. is necessary to cure the PETI.

Recently, alternative end-cappers have been introduced. WO 2011/128431 discloses a novel class of phenylpthynyltrimelleticanhydride based end-cappers, including 5-(3-phenylpropioloyl)isobenzofuran-1,3-dione, which may be cured at lower temperatures than PEPA. Further, also a method for catalyzing the cross-linking of phenylethynyl based end-cappers for polyimides have been introduced (cf. WO 2011/141578). In addition to phenylpthynyltrimelleticanhydride based end-cappers, Nexam Chemical AB have also introduced the cross-linker Neximid® 500 (4-(methylethynyl)phthalic anhydride; 5-(prop-1-yn-1-yl)isobenzofuran-1,3-dione)

However, in some applications there is a need for further improving the heat resistance and mechanical strength of PETI. Especially, it would be of interest to allow for improving the mechanical strength of PETI further. By using 5,5′-(perfluoropropane-2,2-diyl)bis(isobenzofuran-1,3-dione) as aromatic carboxylic acid dianhydride monomer, a PETI resin denoted AFR-PE-4 with improved capability of withstanding heat was obtained in the mid 1990s. However, it would still be of interest to be able to improve the processability, the heat resistance and/or mechanical strength even further also of this resin.

As an alternative to PEPA, also ethynyl phtalic anhydride (EPA) has been used as cross-linker in polyimides (Hergenrother, P. M., “Acetylene-terminated Imide Oligomers and Polymers Therefrom”, Polymer Preprints, Am. Chem. Soc., Vol. 21 (1), p. 81-83, 1980). Further, also ethynyl phthalic anhydride (EPA) end-capped polyimides may benefit from further improved heat resistance and mechanical strength.

U.S. Pat. No. 4,973,707 discloses the use of acetylene bisphthalimides and aromatic diamines to obtain rigid linear polyimides. Polyacetyleneimides, i.e. polyimides resulting from the inter condensation of an acetylene-di(phthalic anhydride) and an aryl diamine, were found to have high glass transition temperatures and good solvent resistance; probably due to the increased rigidity of the polymer backbone compared to polyacetyleneimides of the prior art.

In curing of ethynyl group modified oligomers and polymers, such as PETI, the curing temperature and yield of cross-linking is too a large extent determined by the mobility of the ethynyl group. A more mobile group will have a lower curing temperature and give rise to higher yield of cross-linking. Hence, ethynyl groups used in the art for cross-linking has typically been positioned at the ends of the oligomers and polymers to be cross-linked, cf. PETI, as the end-groups will have higher mobility compared to other parts of the oligomers and polymers.

Further, properties of oligomers and polymers are determined by the specific nature of each monomer. A (high) exchange of one monomer type may lead to impaired polymer properties. Therefore it is preferred to utilize end-groups as they have less influence on polymer properties.

The degree of cross-linking, which may be achieved, is inherently linked to the ratio of cross-linking groups. The ratio of cross-linking end groups may be increased by decreasing the length of the polymer. However, decreasing the length of the polymer will lower the heat resistance and especially the mechanical strength. Further, polymeric properties will be decreased and eventually lost if the length of the polymer is decreased.

Thus, there is need within the art for cross-linkable oligo- and polyimides with improved heat resistance and/or mechanical strength

### SUMMARY

Accordingly, the present invention preferably seeks to mitigate, alleviate, eliminate or circumvent one or more of the above-identified deficiencies in the art and disadvantages singly or in any combination and solves at least the above mentioned problems by providing an oligo- or polyimide comprising one or two residue(s) of an anhydride based acetylenic end-capper, e.g. 5-(phenylethynyl)isobenzofuran-1,3-dione; at least one 5,5′-(ethyne-1,2-diyl)bis(isobenzofuran-1,3-dione) residue or least one 4,4′-(ethyne-1,2-diyl)bis(isobenzofuran-1,3-dione) residue; and at least one residue of an aromatic di-amine. In addition, the oligo- or polyimide may also comprise a residue of an aromatic non-acetylenic di-anhydride.

Further, the present invention also seeks to mitigate, alleviate, eliminate or circumvent one or more of the above-identified deficiencies in the art and disadvantages singly or in any combination and solves at least the above mentioned problems by providing a method of obtaining an oligo- or polyimide, comprising the steps of:
mixing an anhydride based acetylenic end-capper, e.g. 5-(phenylethynyl)isobenzofuran-1,3-dione (PEPA), 5,5′-(ethyne-1,2-diyl)bis(isobenzofuran-1,3-dione) or 4,4′-(ethyne-1,2-diyl)bis(isobenzofuran-1,3-dione), an aromatic di-amine, and optionally a further non-actetylenic aromatic di-anhydride, in a solvent;
allowing the mixed monomers to react for about 1 to 24 hours at a temperature of about 20° C. to 120° C., such as 20° C. to 50° C., to obtain an oligo- or poly(amic acid) comprising residues of said anhydride based acetylenic end-capper, e.g. PEPA, and of 5,5′-(ethyne-1,2-diyl)bis(isobenzofuran-1,3-dione) or 4,4′-(ethyne-1,2-diyl)bis(isobenzofuran-1,3-dione); and
dehydrating the obtained oligo- or poly(amic acid) comprising residues of said anhydride based acetylenic end-capper, e.g. PEPA, and of 5,5′-(ethyne-1,2-diyl)bis(isobenzofuran-1,3-dione) or 4,4′-(ethyne-1,2-diyl)bis(isobenzofuran-1,3-dione) to obtain an oligo- or polyimide.

Another aspect of the invention relates to an oligo- or polyimide obtainable by such a method.

Further aspects of the invention relates to a composition comprising an oligo- or polyimide comprising one or two residue(s) of an anhydride based acetylenic end-capper, e.g. 5-(phenylethynyl)isobenzofuran-1,3-dione, and at least one 5,5′-(ethyne-1,2-diyl)bis(isobenzofuran-1,3-dione) residue or least one 4,4′-(ethyne-1,2-diyl)bis(isobenzofuran-1,3-dione) residue, and to an article comprising an oligo- or polyimide comprising one or two residue(s) of an anhydride based acetylenic end-capper, e.g. 5-(phenylethynyl)isobenzofuran-1,3-dione, and at least one 5,5′-(ethyne-1,2-diyl)bis(isobenzofuran-1,3-dione) residue or least one 4,4′-(ethyne-1,2-diyl)bis(isobenzofuran-1,3-dione) residue.

Further advantageous features of the invention are defined in the dependent claims and described in embodiments disclosed herein

### DESCRIPTION OF EMBODIMENTS

### Definitions

In the context of the present application and invention, the following definitions apply:

As used herein, “alkyl” used alone or as a suffix or prefix, is intended to include both branched and straight chain saturated aliphatic hydrocarbon groups having from 1 to 12 carbon atoms, or if a specified number of carbon atoms is provided then that specific number is intended. For example “C1-6 alkyl” denotes alkyl having 1, 2, 3, 4, 5 or 6 carbon atoms. When the specific number denoting the alkyl-group is the integer 0 (zero), a hydrogen-atom is intended as the substituent at the position of the alkyl-group. For example, “N(C0 alkyl)₂” is equivalent to “NH2” (amino).

Examples of alkyl include, but are not limited to, methyl, ethyl, n-propyl, i-propyl, n-butyl, i-butyl, sec-butyl, t-butyl, pentyl, and hexyl.

As used herein, the term “aryl” refers to a ring structure, comprising at least one aromatic ring, made up of from 5 to 14 carbon atoms. Ring structures containing 5, 6, 7 and 8 carbon atoms would be single-ring aromatic groups, for example phenyl. Ring structures containing 8, 9, 10, 11, 12, 13, or 14 carbon atoms would be polycyclic, for example naphthyl. The aromatic ring may be substituted at one or more ring positions. The term “aryl” also includes polycyclic ring systems having two or more cyclic rings in which two or more carbons are common to two adjoining rings (the rings are “fused rings”) wherein at least one of the rings is aromatic, for example, the other cyclic rings may be cycloalkyls, cycloalkenyls, cycloalkynyls, and/or aryls.

The terms ortho, meta and para apply to 1,2-, 1,3- and 1,4-disubstituted benzenes, respectively. For example, the names 1,2-dimethylbenzene and ortho-dimethylbenzene are synonymous.

As used herein, the term “substitutable” refers to an atom to which a hydrogen may be covalently attached, and to which another substituent may be present instead of the hydrogen. A non-limiting example of substitutable atoms includes the carbon-atoms of pyridine. The nitrogen-atom of pyridine is not substitutable according to this definition. Further, according to the same definition, the imine nitrogen at position 3 in imidazole is not substitutable, while the amine nitrogen at position 1 is.

### Embodiments

An embodiment of the present invention relates to an oligo- or polyimide comprising one or two residue(s) of an anhydride based acetylenic end-capper, such as 5-(phenylethynyl)isobenzofuran-1,3-dione (PEPA), 5-ethynylisobenzofuran-1,3-dione (EPA), 5-(3-phenylpropioloyl)isobenzofuran-1,3-dione (PETA) or 5-(prop-1-yn-1-yl)isobenzofuran-1,3-dione (MEPA), at least one 5,5′-(ethyne-1,2-diyl)bis(isobenzofuran-1,3-dione) (EBPA) residue, and at least one residue of an aromatic di-amine. Although not necessary, such an oligo- or polyimide will typically also comprise at least one residue of an aromatic non-acetylenic di-anhydride.

According to an embodiment, the 5,5′-(ethyne-1,2-diyl)bis(isobenzofuran-1,3-dione) (EBPA) residue may be replaced or complemented with a 4,4′-(ethyne-1,2-diyl)bis(isobenzofuran-1,3-dione) residue, i.e. a corresponding symmetrical positional isomer. In Chemistry of Materials, 2001, 13, 2472-2475, the synthesis of 4,4′-(ethyne-1,2-diyl)bis(isobenzofuran-1,3-dione) residue, is described.

A preferred embodiment of the present invention relates to an oligo- or polyimide comprising one or two 5-(phenylethynyl)isobenzofuran-1,3-dione (PEPA), 5-ethynylisobenzofuran-1,3-dione (EPA), 5-(3-phenylpropioloyl)isobenzofuran-1,3-dione (PETA) or 5-(prop-1-yn-1-yl)isobenzofuran-1,3-dione (MEPA) residue(s), at least one 5,5′-(ethyne-1,2-diyl)bis(isobenzofuran-1,3-dione) (EBPA) residue, and at least one residue of an aromatic di-amine. Although not necessary, such an oligo- or polyimide will typically also comprise at least one residue of an aromatic non-acetylenic di-anhydride.

The structures of PEPA, EBPA, PETA, MEPA, and EPA, as well as their chemical names are provided below.

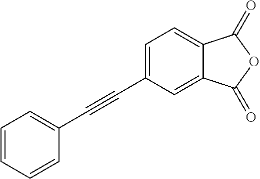 [SMILES: O=C1OC(=O)c2cc(C#Cc3ccccc3)ccc21]

5-(phenylethynyl)isobenzofuran-1,3-dione (PhenylEthynyl Phtalic Anhydride; PEPA)

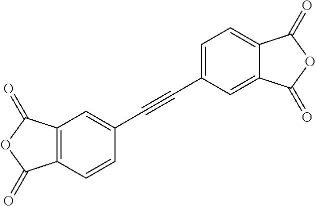 [SMILES: O=C1OC(=O)c2cc(C#Cc3ccc4c(c3)C(=O)OC4=O)ccc21]

5,5′-(ethyne-1,2-diyl)bis(isobenzofuran-1,3-dione) (Ethynyl Bis-Phtalic Anhydride; EBPA)

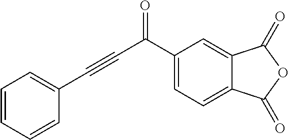 [SMILES: O=C(C#Cc1ccccc1)c1ccc2c(c1)C(=O)OC2=O]

5-(3-phenylpropioloyl)isobenzofuran-1,3-dione (4-(PhenylEhynyl)Phthalic Anhydride; PETA)

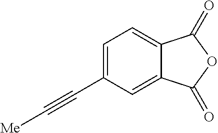 [SMILES: CC#Cc1ccc2c(c1)C(=O)OC2=O]

5-(prop-1-yn-1-yl)isobenzofuran-1,3-dione (4-(MethylEthynyl)Phthalic Anhydride; MEPA)

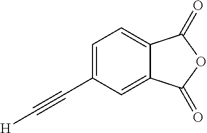 [SMILES: C#Cc1ccc2c(c1)C(=O)OC2=O]

5-ethynylisobenzofuran-1,3-dione (4-(Ethynyl)Phthalic Anhydride; EPA)

An oligo- or polyimide comprising at least one residue of an anhydride based acetylenic end-capper, e.g. 5-(phenylethynyl)isobenzofuran-1,3-dione (PEPA), as end-group and at least one 5,5′-(ethyne-1,2-diyl)bis(isobenzofuran-1,3-dione) or 4,4′-(ethyne-1,2-diyl)bis(isobenzofuran-1,3-dione) residue the in-chain, will allow for higher cross-linking density compared to an oligo- or polyimide only comprising at least one residue of an anhydride based acetylenic end-capper, e.g. 5-(phenylethynyl)isobenzofuran-1,3-dione (PEPA) residue, as end-group. Thus, oligo- and polyimides comprising residues of an anhydride based acetylenic end-capper, e.g. PEPA and EBPA or 4,4′-(ethyne-1,2-diyl)bis(isobenzofuran-1,3-dione)will have improved heat resistance and/or mechanical strength compared to the corresponding oligo- and polyimides only having cross-linkable end-groups, such as PEPA residues, once cross-linked.

By replacing at least one of the non-acetylenic di-anhydride monomers present in oligo- or polyimide, with EBPA or 4,4′-(ethyne-1,2-diyl)bis(isobenzofuran-1,3-dione), cross-linkable carbon-carbon triple bonds may be incorporated into the oligo- or polyimide chain. As EBPA and 4,4′-(ethyne-1,2-diyl)bis(isobenzofuran-1,3-dione) also are an aromatic carboxylic di-anhydrides, insertion of them into the oligo- or polyimide chain most likely will only have a limited effect on the properties of the oligo- or polyimide.

According to an embodiment, the residue of an aromatic di-amine in the oligo- or polyimide comprising residues of an anhydride based acetylenic end-capper, e.g. PEPA, and EBPA or 4,4′-(ethyne-1,2-diyl)bis(isobenzofuran-1,3-dione), is a residue of 1,4-diaminobenzene, 1,3-diaminobenzene or a residue of a di-amine according to general formula (I)

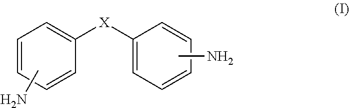

wherein

the amino groups may be connected to any carbon atoms in the benzene residues, i.e. to the 2-, 3- or 4-position, and the 2′, 3′, or 4′-position, respectively; and

X is a direct bond or a moiety selected from the group consisting of —O—, —S—, —C(O)—, —C(CH₃)₂—, —C(CF₃)₂—, —CH₂—, 3-oxyphenoxy group, 4-oxyphenoxy group, 4′-oxy-4-biphenoxy group, and 4-[1-(4-oxyphenyl)-1-methylethyl]phenoxy group. Preferably, the amino groups are connected to the 3- or 4-position of the respective benzene residues. Symmetric di-amines, i.e. 3,3′- and 4,4′-substited di-amines according to general formula (I), as well as asymmetric di-amines, i.e. 3,4′-, or 4,3′-substited di-amines according to general formula (I), are equally possible.

As well known in the art, asymmetric di-amines and di-anhydrides may be used to prepare polyimides with a bent and rotationally hindered structure resulting in high Tg but also in improved processability and high melt fluidity along with solubility of the resin in organic solvent.

Examples of preferred aromatic di-amines to be included in oligo- or polyimide, comprising residues of an anhydride based acetylenic end-capper, e.g. PEPA, and EBPA or 4,4′-(ethyne-1,2-diyl)bis(isobenzofuran-1,3-dione), comprises 4,4′-oxydianiline, 1,4-diaminobenzene, 1,3-diaminobenzene, 1,3-bis-(4-aminophenoxy)benzene, 1,3-bis-(3-aminophenoxy)benzene, methylenedianiline, 4,4′-diaminodiphenyl sulfone and 3,4′-oxydianiline.

According to one embodiment, the residue of an aromatic non-acetylenic di-anydride optionally present in the oligo- or polyimide comprising residues of an anhydride based acetylenic end-capper, e.g. PEPA, and EBPA or 4,4′-(ethyne-1,2-diyl)bis(isobenzofuran-1,3-dione), is a residue of pyromellitic dianhydride or a residue of a di-anhydride according to general formula (II),

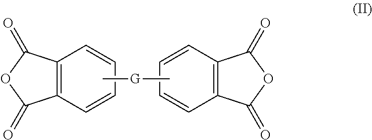

wherein G represents a direct bond or a di-valent group selected from the group consisting of a carbonyl group, a methylene group, a sulfone group, a sulfide group, an ether group, an —C(O)-phenylene-C(O)— group, an isopropylidene group, a hexafluoroisopropylidene group, a 3-oxyphenoxy group, a 4-oxyphenoxy group, a 4′-oxy-4-biphenoxy group, and a 4-[1-(4-oxyphenyl)-1-methylethyl]phenoxy group; and G may be connected to the 4- or 5-position and the 4′- or the 5′-position, respectively, in the isobenzofuran-1,3-dione residues.

Symmetric aromatic non-acetylenic di-anhydrides as well aromatic non-acetylenic di-anhydrides are equally possible.

Preferred examples of aromatic non-acetylenic di-anydrides to be included in oligo- or polyimide comprising residues of an anhydride based acetylenic end-capper, e.g. PEPA, and EBPA or 4,4′-(ethyne-1,2-diyl)bis(isobenzofuran-1,3-dione)include pyromellitic di-anhydride, 4,4′-oxydiphthalic anhydride, 2,2-bis-[4-(3,4-dicarboxyphenoxy)phenyl]-propane di-anhydride, 3,3′,4,4′-benzophenonetetracarboxylic acid di-anhydride, 3,3′,4,4′-tetracarboxybiphenyl di-anhydride, 4,4′,5,5′-sulfonyldiphthalic anhydride, and 5,5′-(perfluoropropane-2,2-diyl)bis(isobenzofuran-1,3-dione).

To provide a better understanding of the invention, an example of a representative oligoimide comprising PEPA and EBPA residues is provided below.

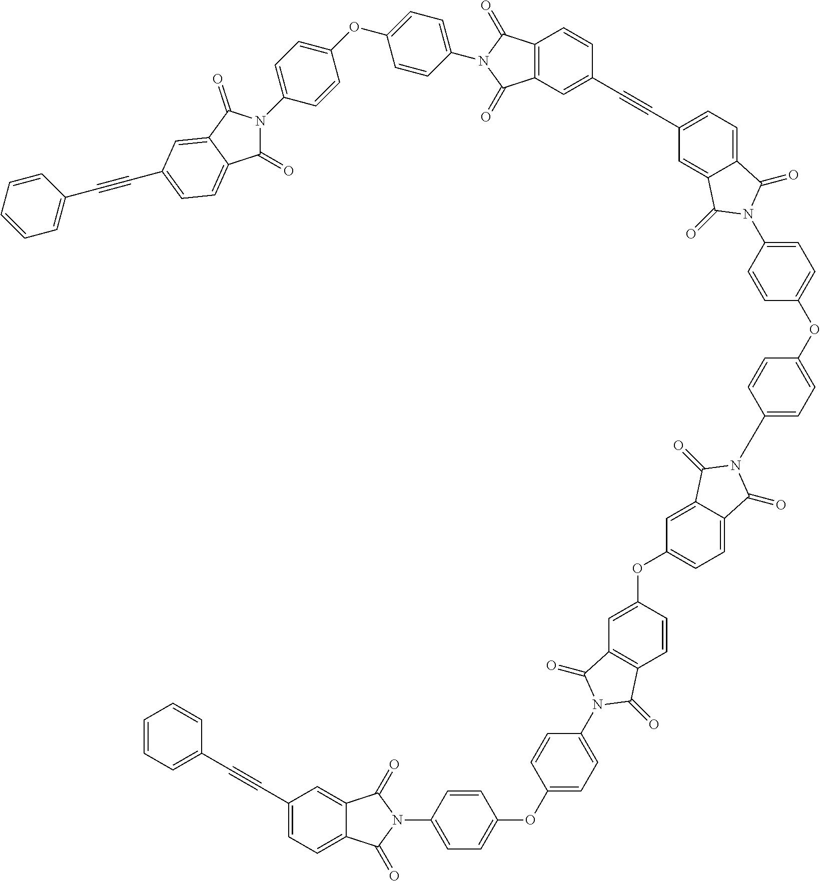 [SMILES: O=C1c2ccc(C#Cc3ccccc3)cc2C(=O)N1c1ccc(Oc2ccc(N3C(=O)c4ccc(C#Cc5ccc6c(c5)C(=O)N(c5ccc(Oc7ccc(N8C(=O)c9ccc(Oc%10ccc%11c(c%10)C(=O)N(c%10ccc(Oc%12ccc(N%13C(=O)c%14ccc(C#Cc%15ccccc%15)cc%14C%13=O)cc%12)cc%10)C%11=O)cc9C8=O)cc7)cc5)C6=O)cc4C3=O)cc2)cc1]

The exemplified oligoimide constitutes of the following monomers (counter clockwise): PEPA; 4,4′-oxydianiline; 4,4′-oxydiphthalic anhydride; 4,4′-oxydianiline; EBPA; 4,4′-oxydianiline; and PEPA.

Although PEPA is the preferred end-capper for oligo- or polyimide disclosed herein, other anhydride based acetylenic end-cappers, such as ethynyl phtalic anhydride (EPA), may be used as well.

Further, also such anhydride based acetylenic end-cappers as disclosed in U.S. Pat. No. 5,681,967 may be used. Examples of such anhydride based acetylenic end-cappers are anhydrides according to formula (V)

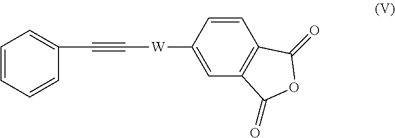

wherein W is a radical selected from the group consisting of

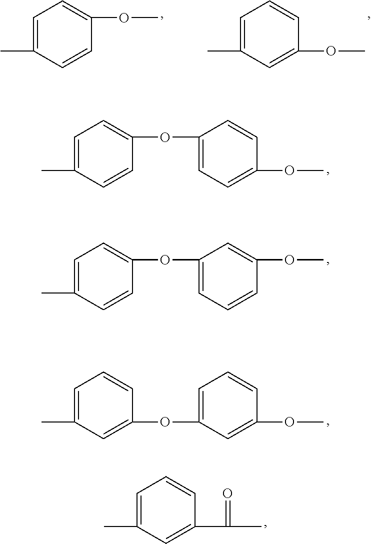

### and —C(O)—.

As described in WO 2011/128431, a compound according to formula (V), wherein “W” is —C(O)—, may be cured at lower temperatures compared to PEPA, i.e. a compound according to formula (V), wherein “W” is a direct bond.

The present inventors have also developed the cross-linker MEPA (4-(MethylEthynyl)Phthalic Anhydride; 5-(prop-1-yn-1-yl)isobenzofuran-1,3-dione) sold under the trademark Neximid® 500 by Nexam Chemical AB, which may be used as anhydride based acetylenic end-capper. MEPA may be synthesized by:
mixing bromophtalic anhydride, triethylamine, and toluene in a glass reactor over nitrogen (g) atmosphere at room temperature;
adding bis(triphenylphosphine)palladiumchloride, CuI, triphenylphosphine and raising the temperature to 50° C.; and
slowly adding propyne through a gas inlet.

Subsequently, the reaction mixture may be filtered through a glass filter funnel and the solution concentrated to dryness to give a crude solid product. The crude product may be re-crystallized from toluene to improve its purity.

Further, also substituted, PEPA-based acetylenic end-cappers may be used as anhydride based acetylenic end-cappers. Examples of such substituted PEPA-based acetylenic end-cappers are anhydrides according to formula (VV)

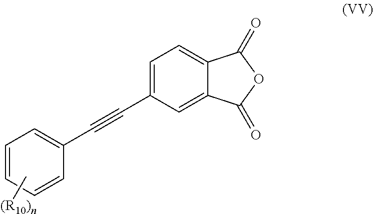

wherein

“n” is an integer of 1 to 5; such as 1 or 2: preferably 1; and

R₁₀ is, independently of each other if the integer “n”>1, selected from the group consisting of halogen, such as fluoro, nitro, aryl, such as phenyl and naphtyl, benzyl, phenoxy, C1-4 alkyl, such as methyl or tert-butyl, cyano, trifluoromethyl, and benzoyl. In compounds according to formula (VV), the substituent(s) R₁₀ may be connected to any substitutable carbon atom of the phenyl group. If the integer “n” is 1, then R₁₀ is preferably in para-position. The molar ratio of the various residues in the oligo- or polyimide comprising residues of an anhydride based acetylenic end-capper, e.g. PEPA, and EBPA or 4,4′-(ethyne-1,2-diyl)bis(isobenzofuran-1,3-dione) may vary.

As an example, an oligo- or polyimide comprising residues of an anhydride based acetylenic end-capper, e.g. PEPA, and EBPA and having low molecular weight, e.g. comprising less than 20 di-amine residues, may comprise, such as consist of:
one or two residues of an anhydride based acetylenic end-capper, e.g. 5-(phenylethynyl)isobenzofuran-1,3-dione;
at least one 5,5′-(ethyne-1,2-diyl)bis(isobenzofuran-1,3-dione) residue, such as one to ten 5,5′-(ethyne-1,2-diyl)bis(isobenzofuran-1,3-dione) residues;
at least one but less than twenty residues of an aromatic di-amine; and
optionally at least one residue of an aromatic non-acetylenic di-anhydride, such as such as ten to nineteen residues of an aromatic non-acetylenic di-anhydride;

wherein the sum of the number of 5,5′-(ethyne-1,2-diyl)bis(isobenzofuran-1,3-dione) residues and residues of aromatic non-acetylenic di-anhydrides is less than twenty.

As a further example, an oligo- or polyimide comprising residues of an anhydride based acetylenic end-capper, e.g. PEPA, and EBPA and having intermediate molecular weight, e.g. comprising 20 or more di-amine residues, but less than 200 di-amine residues, may comprise, such as consist of:
one or two residues of an anhydride based acetylenic end-capper, e.g. 5-(phenylethynyl)isobenzofuran-1,3-dione
at least one 5,5′-(ethyne-1,2-diyl)bis(isobenzofuran-1,3-dione) residue, such as 1 to 100 5,5′-(ethyne-1,2-diyl)bis(isobenzofuran-1,3-dione) residues;
at least 20 but less than 200 residues of an aromatic di-amine; and
optionally at least one residue of an aromatic non-acetylenic di-anhydride, such as 100 to 199 residues of an aromatic non-acetylenic di-anhydride;
wherein the sum of the number of 5,5′-(ethyne-1,2-diyl)bis(isobenzofuran-1,3-dione) residues and residues of aromatic non-acetylenic di-anhydrides is at least 20 but less than 200.

As an additional example, an oligo- or polyimide comprising residues of an anhydride based acetylenic end-capper, e.g. PEPA, and EBPA and having high molecular weight, e.g. comprising at least 200 di-amine residues, may comprise, such as consist of:
one or two residues of an anhydride based acetylenic end-capper, e.g. 5-(phenylethynyl)isobenzofuran-1,3-dione;
at least one 5,5′-(ethyne-1,2-diyl)bis(isobenzofuran-1,3-dione) residue, such as one to at least 100 5,5′-(ethyne-1,2-diyl)bis(isobenzofuran-1,3-dione) residues;
at least 200 residues of an aromatic di-amine; and
optionally at least one residue of an aromatic non-acetylenic di-anhydride, such as at least 100 residues of an aromatic non-acetylenic di-anhydride;

wherein the sum of the number of 5,5′-(ethyne-1,2-diyl)bis(isobenzofuran-1,3-dione) residues and residues of aromatic non-acetylenic di-anhydrides is at least 200.

According to one embodiment, the weight average molecular weight of an oligoimide comprising residues of an anhydride based acetylenic end-capper, e.g. PEPA, and EBPA or 4,4′-(ethyne-1,2-diyl)bis(isobenzofuran-1,3-dione) may be about 1,000 to 10,000, such as about 2,500 to 7,500, while the weight average molecular weight of the polyimide comprising residues of an anhydride based acetylenic end-capper, e.g. PEPA, and EBPA or 4,4′-(ethyne-1,2-diyl)bis(isobenzofuran-1,3-dione) residues may be 10,000 to 200,000, such as 25,000 to 100,000.

As well known within the art, the preparation of oligo- and polyimides are preferably performed in, but not limited to, aprotic solvents, such as dimethylacetamide, dimethylformamide or N-Methylpyrrolidone. Further examples of solvents and mixtures of solvents used in the preparation of oligo- and polyimides are cresol, cresol/toluene, N-Methylpyrrolidone/ortho-dichlorobenzene, benzoic acid, and nitrobenzene. Such solvents may be used to obtain oligo- and polyimides comprising residues of an anhydride based acetylenic end-capper, e.g. PEPA, and EBPA or 4,4′-(ethyne-1,2-diyl)bis(isobenzofuran-1,3-dione) as well.

Even further examples of solvents include:

Phenol solvents, such as phenol, o-chlorophenol, m-chlorophenol, p-chlorophenol, o-cresol, m-cresol, p-cresol, 2,3-xylenol, 2,4-xylenol, 2,5-xylenol, 2,6-xylenol, 3,4-xylenol, and 3,5-xylenol;

Aprotonic amide solvents, such as N,N-dimethylformamide, N,N-dimethylacetamide, N,N-diethylacetamide, N-methyl-2-pyrrolidone, 1,3-dimethyl-2-imidazolidine, N-methylcaprolactam, and hexamethylphosphorotriamide;

Ether solvents, such as 1,2-dimethoxyethane, bis(2-methoxyethyl) ether, 1,2-bis(2-methoxyethoxy)ethane, tetrahydrofuran, bis[2-(2-methoxyethoxy)ethyl] ether, 1,4-dioxane, and diphenyl ether;

Amine solvents, such as pyridine, quinoline, isoquinoline, alpha-picoline, beta-picoline, gamma-picoline, isophorone, piperidine, 2,4-lutidine, 2,6-lutidine, trimethylamine, triethylamine, tripropylamine, and tributylamine; as well as

Other solvents, such as dimethyl sulfoxide, dimethyl sulfone, sulphorane, diphenyl sulfone, tetramethylurea, anisole, and water.

Further, alkanols, such as methanol or ethanol, may be used as solvent in obtaining oligo- and polyimides comprising residues of an anhydride based acetylenic end-capper, e.g. PEPA, and EBPA or 4,4′-(ethyne-1,2-diyl)bis(isobenzofuran-1,3-dione).

In preparing oligo- and polyimides comprising residues of an anhydride based acetylenic end-capper, e.g. PEPA, and EBPA or 4,4′-(ethyne-1,2-diyl)bis(isobenzofuran-1,3-dione), the weight ratio of monomers:solvent is typically 1:10 to 1:1. Similar, oligo- and polyimides comprising residues of an anhydride based acetylenic end-capper, e.g. PEPA, and EBPA or 4,4′-(ethyne-1,2-diyl)bis(isobenzofuran-1,3-dione) are typically prepared at a dry weight of the monomers corresponding to about 10 to 40 wt %.

Oligo- and polyimides in the art are often obtained in two-stage procedure, wherein the monomers are mixed in a solvent at ambient or at slightly elevated temperature, typically from about 20° C. to 120° C., such as 25° C. to 50° C., to obtain an oligo- or a polyamic acid as intermediate. The obtained oligo- or polyamic acid intermediate is subsequently imidized at a much higher temperature, such as about 180° C., by dehydration eliminating water.

The dehydration, may also be chemically driven, such as by addition if acetic anhydride, whereby by the imidization may be performed at lower temperature, such as about 100 to 150° C.

Oligo- and polyimides comprising residues of an anhydride based acetylenic end-capper, e.g. PEPA, and EBPA or 4,4′-(ethyne-1,2-diyl)bis(isobenzofuran-1,3-dione) may be obtained in a similar procedure, wherein also the anhydride based acetylenic end-capper, e.g. PEPA, and EBPA or 4,4′-(ethyne-1,2-diyl)bis(isobenzofuran-1,3-dione) are added to the solvent. As EBPA and 4,4′-(ethyne-1,2-diyl)bis(isobenzofuran-1,3-dione) are a di-anhydrides, they may replace the aromatic non-acetylenic di-anhydride. However, preferably EBPA or 4,4′-(ethyne-1,2-diyl)bis(isobenzofuran-1,3-dione) as well as an aromatic non-acetylenic di-anhydride is used.

The reaction temperature during the first stage, i.e. formation of oligo- or poly(amic acid), is typically about 20° C. to 120° C., such as 20° C. to 50° C., e.g. about 25° C. After about 1 to 24 hours, the temperature may be raised to initiate cyclo dehydration of oligo- or poly(amic acid) into oligo- or polyimide. The temperature is typically raised to about 170° C. to 200° C. The cyclo dehydration may be performed for about 3 to 24 hours.

Various molar ratios of anhydride based acetylenic end-cappers, such as PEPA, EBPA or 4,4′-(ethyne-1,2-diyl)bis(isobenzofuran-1,3-dione), aromatic di-amine, and optionally aromatic non-acetylenic di-anhydride may be used. Further, the relative molar amount of the aromatic di-amine and/or the anhydride based acetylenic end-cappers, such as PEPA, acting as chain terminator, may be used to control the degree of polymerization.

According to one embodiment, the following relative molar amount of an anhydride based acetylenic end-capper, e.g. PEPA, EBPA or 4,4′-(ethyne-1,2-diyl)bis(isobenzofuran-1,3-dione), aromatic di-amine, and optionally aromatic non-acetylenic di-anhydride may be used to obtain oligo- and polyimides comprising residues of an anhydride based acetylenic end-capper, e.g. PEPA, and EBPA or 4,4′-(ethyne-1,2-diyl)bis(isobenzofuran-1,3-dione):
di-amine: 1+X
di-anhydride: Y
EBPA or 4,4′-(ethyne-1,2-diyl)bis(isobenzofuran-1,3-dione): 1-Y anhydride based acetylenic end-capper, e.g. PEPA: Z
wherein,
X is about 0.001 to 1, such as 0.01 to 0.15;
Y is about 0.01 to 0.9, such as 0.1 to 0.7; and
Z is about 0.001 to 3, such as 0.02 to 0.3.

As the oligo- or polyimide is to be end-capped with anhydride based acetylenic end-capper, e.g. PEPA, it is preferred to employ a slight excess of the di-amine compared to the combined amount of the di-anhydride and EBPA or 4,4′-(ethyne-1,2-diyl)bis(isobenzofuran-1,3-dione).

According to another embodiment, the following relative molar amount of an anhydride based acetylenic end-capper, e.g. PEPA, EBPA or 4,4′-(ethyne-1,2-diyl)bis(isobenzofuran-1,3-dione), aromatic di-amine, and optionally aromatic non-acetylenic di-anhydride may be used to obtain oligo- and polyimides comprising residues of an anhydride based acetylenic end-capper, e.g. PEPA and EBPA or 4,4′-(ethyne-1,2-diyl)bis(isobenzofuran-1,3-dione):
di-amine: 1.01 to 1.2;
di-anhydride: 0.1 to 0.9;
EBPA or 4,4′-(ethyne-1,2-diyl)bis(isobenzofuran-1,3-dione): 0.1 to 0.9; and
anhydride based acetylenic end-capper, e.g. PEPA: 0.01 to 0.3

with the proviso that the sum of the relative molar amount of di-anhydride and EBPA or 4,4′-(ethyne-1,2-diyl)bis(isobenzofuran-1,3-dione) equals 1.

Examples of molar ratios of monomers which may be used to obtain oligo- or polyimide comprising residues of anhydride based acetylenic end-capper, e.g. PEPA, and EBPA with various weight average molecular weights are provided below. As can been seen, the relative molar amount of the end-capper, e.g. PEPA in the provided example, will affect the molecular weight of the polymer obtained.

| Polymer Mw | 5,000 n | 10,000 n | 25,000 n |
|---|---|---|---|
| 6FDA | 0.500 | 0.500 | 0.500 |
| ODA | 1.134 | 1.060 | 1.023 |
| PEPA | 0.286 | 0.124 | 0.046 |
| EBPA | 0.500 | 0.500 | 0.500 |

6FDA = 5,5′-(perfluoropropane-2,2-diyl)bis(isobenzofuran-1,3-dione);
ODA = 4,4′-oxydianiline;
PEPA = 5-(phenylethynyl)isobenzofuran-1,3-dione; and
EBPA = 5,5′-(ethyne-1,2-diyl)bis(isobenzofuran-1,3-dione)

Pages 137 to 139 in the dissertation thesis “Synthesis and characterization of thermosetting polyimide oligomers for microelectronics packaging” by Debra Lynn Dunson, from 2000, provides guidance for calculating the molar ratios if using monomers with other molecular weights. Further, the thesis also provides guidance for obtaining other oligo- and polyimides with other weight average molecular weights. In-addition the thesis provides information relating to the preparation of PEPA end-capped oligo- and polyimides. Similar procedures may be employed to prepare oligo- and polyimides comprising EBPA and PEPA residues. Further, the procedure may be employed to prepare oligo- and polyimides comprising residues of other anhydride based acetylenic end-cappers than PEPA or residues of 4,4′-(ethyne-1,2-diyl)bis(isobenzofuran-1,3-dione). Thus, the dissertation thesis “Synthesis and characterization of thermosetting polyimide oligomers for microelectronics packaging” by Debra Lynn Dunson, from 2000 is incorporated herein by reference.

Rather than adding the anhydride based acetylenic end-capper, e.g. PEPA initially, the anhydride based acetylenic end-capper, e.g. PEPA, may also be added subsequently to the reaction of the aromatic di-amine, EBPA and optionally the aromatic di-anhydride, i.e. the anhydride based acetylenic end-capper, e.g. PEPA, may be used to end-cap an obtained oligo- or poly(amic acid) comprising EBPA residues. Subsequently the end-capped oligo- or poly(amic acid) comprising residues of the anhydride based acetylenic end-capper, e.g. PEPA, and EBPA may be cyclo dehydrated to obtain oligo- or polyimide comprising residues of the anhydride based acetylenic end-capper, e.g. PEPA, and EBPA.

A further embodiment of the present invention relates to a method of obtaining an oligo- or polyimide comprising residues of an anhydride based acetylenic end-capper, e.g. PEPA, and 5,5′-(ethyne-1,2-diyl)bis(isobenzofuran-1,3-dione) (EBPA) or 4,4′-(ethyne-1,2-diyl)bis(isobenzofuran-1,3-dione); preferably 5,5′-(ethyne-1,2-diyl)bis(isobenzofuran-1,3-dione) (EBPA). In such a method an anhydride based acetylenic end-capper, e.g. 5-(phenylethynyl)isobenzofuran-1,3-dione (PEPA), 5,5′-(ethyne-1,2-diyl)bis(isobenzofuran-1,3-dione) (EBPA) or 4,4′-(ethyne-1,2-diyl)bis(isobenzofuran-1,3-dione), an aromatic di-amine, and optionally an aromatic non-actetylenic di-anhydride are mixed in a solvent. Examples of solvents, anhydride based acetylenic end-cappers, aromatic di-amines, and aromatic non-actetylenic di-anhydrides, are provided herein above. The monomers are subsequently allowed to react for about 1 to 24 hours at a temperature of about 20° C. to 120° C., such as 20° C. to 50° C., e.g. about 25° C., to obtain an oligo- or poly(amic acid) comprising residues of the anhydride based acetylenic end-capper, e.g. PEPA, and EBPA or 4,4′-(ethyne-1,2-diyl)bis(isobenzofuran-1,3-dione). The obtained oligo- or poly(amic acid) comprising residues of the anhydride based acetylenic end-capper, e.g. PEPA, and EBPA or 4,4′-(ethyne-1,2-diyl)bis(isobenzofuran-1,3-dione)may subsequently be dehydrated to obtain an oligo- or polyimide comprising residues of the anhydride based acetylenic end-capper, e.g. PEPA, and EBPA or 4,4′-(ethyne-1,2-diyl)bis(isobenzofuran-1,3-dione).

As readily known to the skilled artisan, oligo- or poly(amic acids) may be dehydrated in various ways. As already described, oligo- or poly(amic acid) comprising residues of an anhydride based acetylenic end-capper, e.g. PEPA, and EBPA or 4,4′-(ethyne-1,2-diyl)bis(isobenzofuran-1,3-dione) may be dehydrated by raising the temperature to about 170° C. to 200° C. for about 3 to 24 hours subsequently to the initially reaction at 20° C. to 120° C. for about 1 to 24 hours. The obtained oligo- or polyimide comprising residues of an anhydride based acetylenic end-capper, e.g. PEPA, and EBPA or 4,4′-(ethyne-1,2-diyl)bis(isobenzofuran-1,3-dione) may then be isolated by removing the solvent.

Further, the imidization may be performed at a somewhat lower temperature, e.g. about 120-150° C., if an chemical dehydration agent, such as anhydrides, eg. acetic anhydride, is added. Further, other drying agents, such as orthoesters, eg. triethyl orthoformate, coupling reagents, eg. carbodiimides, such as dicyclohexylcarbodiimide (DCC) and diisopropylcarbodiimide (DIC), may be used as chemical dehydration agents. Coupling reagents on solid support may also be used as chemical dehydration agents.

In addition, the imidization may even take place during moulding, such as compression moulding, of the oligo- or poly(amic acid) comprising residues of an anhydride based acetylenic end-capper, e.g. PEPA, and EBPA or 4,4′-(ethyne-1,2-diyl)bis(isobenzofuran-1,3-dione). In compression moulding, the mould is typically heated to temperatures 20-50° C. above the softening point before closing the mould. Subsequently to a heat driven imidization and closing the mould, cross-linking, which also may be denoted curing, of the obtained oligo- or polyimide comprising residues of an anhydride based acetylenic end-capper, e.g. PEPA, and EBPA or 4,4′-(ethyne-1,2-diyl)bis(isobenzofuran-1,3-dione) is performed by raising the temperature further, such as to about e.g. 380-400° C.

A poly(amic acid) is usually converted to the final polyimide by the thermal imidization route. While the specific thermal cycles utilized are many, they can essentially be divided into two different types;

1) Heating gradually to 250° C.-350° C., depending on the stability and Tg of the polyimide.

2) Heating the poly(amic acid) mixture to 100° C. and holding for one hour, heating from 100° C. to 200° C. and holding for one hour, heating from 200° C. to 300° C. and holding for one hour and slow cooling to room temperature from 300° C.

The chemical imidization of the poly(amic acids) is a useful technique for manufacturing molding powders. The process essentially consists of treating the poly(amic acid) with a mixture of aliphatic carboxylic acid dianhydride and tertiary amine at ambient to reflux temperatures. The common reagents utilized are acetic anhydride, pyridine and triethylamine. The final polyimide formed is usually insoluble in the imidization mixture and hence precipitates out. In general though, the chemical imidization technique requires a final treatment where the it is heated briefly to temperatures near 300° C. or above the Tg to complete the imidization and remove traces of any solvent.

One step high temperature solution polymerization technique is employed for polyimides that are soluble in organic solvents at polymerization temperatures. The process involves heating the mixture of monomers in a high boiling solvent or a mixture of solvents at 180° C.-220° C. Water generated due to the reaction is distilled off continuously as an azeotrope along with the solvent. The commonly utilized solvents are nitrobenzene, m-cresol and dipolar aprotic amide solvents. The polymerization is often performed in the presence of catalysts such as quinoline, tertiary amines, alkali metals and zinc salts of carboxylic acids. This process is especially useful for polymerization involving unreactive di-anhydrides and di-amines. An interesting feature of this method is that it often yields materials with a higher degree of crystallinity than can be obtained with two-step methods.

A further embodiment of the present invention relates to an oligo- or polyimide comprising residues of an anhydride based acetylenic end-capper, e.g. PEPA, and EBPA or 4,4′-(ethyne-1,2-diyl)bis(isobenzofuran-1,3-dione)obtainable by methods disclosed herein.

Another embodiment relates to a composition comprising an oligo- or polyimide comprising residues of an anhydride based acetylenic end-capper, e.g. PEPA and EBPA or 4,4′-(ethyne-1,2-diyl)bis(isobenzofuran-1,3-dione). The composition may further comprise at least one additional polymer, such as at least one additional oligo- or polyimide, and/or at least one filler, reinforcement, pigment, plasticizer and/or any other additive known in the art. The oligo- or polyimide comprising residues of an anhydride based acetylenic end-capper, e.g. PEPA, and EBPA or 4,4′-(ethyne-1,2-diyl)bis(isobenzofuran-1,3-dione) is preferably present in an amount corresponding to at least 10 wt %, such as at least 25, 40, 60, or 80 wt % of the composition.

Another embodiment relates to an article comprising an oligo- or polyimide comprising residues of an anhydride based acetylenic end-capper, e.g. PEPA, and EBPA or 4,4′-(ethyne-1,2-diyl)bis(isobenzofuran-1,3-dione). Optionally, the oligo- or polyimide in the article has been cross-linked by heating it.

Examples of such articles include flexible films for electronics, wire isolation, wire coatings, wire enamels, ink, and load-bearing structural components. Further examples of articles comprising an oligo- or polyimide comprising residues of an anhydride based acetylenic end-capper, e.g. PEPA, and EBPA or 4,4′-(ethyne-1,2-diyl)bis(isobenzofuran-1,3-dione)include molding resins/parts, wire enamels, films, fibers, prepregs, composites, laminates, coatings, foams, and adhesives.

Without further elaboration, it is believed that one skilled in the art may, using the preceding description, utilize the present invention to its fullest extent. The preceding preferred specific embodiments are, therefore, to be construed as merely illustrative and not limitative of the disclosure in any way whatsoever.

Although the present invention has been described above with reference to specific embodiments, it is not intended to be limited to the specific form set forth herein. Rather, the invention is limited only by the accompanying claims and, other embodiments than the specific above are equally possible within the scope of these appended claims, e.g. different than those described above.

In the claims, the term “comprises/comprising” does not exclude the presence of other elements or steps. Additionally, although individual features may be included in different claims, these may possibly advantageously be combined, and the inclusion in different claims does not imply that a combination of features is not feasible and/or advantageous.

In addition, singular references do not exclude a plurality. The terms “a”, “an”, “first”, “second” etc do not preclude a plurality.

### EXAMPLES

### Brief Description of the Drawings

FIG. 1 depicts a DSC-thermogram for an uncured EPBA/PEPA-resin.

FIG. 2 depicts a DSC-thermogram for a cured EPBA/PEPA-resin.

FIG. 3 depicts a RDA for an EPBA/PEPA-resin and a corresponding PEPA-resin, respectively.

The following examples are mere examples and should by no mean be interpreted to limit the scope of the invention. Rather, the invention is limited only by the accompanying claims.

The classic two-step route of polyimide synthesis involves the preparation of a poly(amic acid) in the initial step, followed by cyclo-dehydration of the polymer in the second step. The latter step can be performed either by thermal, chemical or solution methods.

### General Example

The following is a general example to obtain oligo- or polyimides comprising PEPA and EBPA residues with a target weight average molecular weight of 10,000.

To a reactor equipped with a mechanical stirrer and nitrogen inlet, fresh N-methylpyrrolidone (900 ml) and 4,4′-oxydianiline (1.060 mol) is added. The resulting mixture is stirred under nitrogen flow to completely dissolve the di-amine. Then EBPA (0.500 mol), 5,5′-(perfluoropropane-2,2-diyl)bis(isobenzofuran-1,3-dione) (0.500 mol) and PEPA (0.124 mol) is gradually rinsed into the di-amine solution by use of N-Methylpyrrolidone (210 ml). The resulting mixture is then be stirred under a steady nitrogen flow while the anhydrides gradually dissolve (usually completed within a few hours). Once the reaction solution becomes homogeneous, the stirring is continued at the same conditions (ambient temperature, nitrogen purge) for 20 hours. Typically, the resulting clear, yellow to dark brown poly(amic acid) solution has somewhat higher viscosity than the initial monomer solution.

This solution is then used as it is, concentrated and then used, pre-imidized then used or fully imidized and then used to prepare films or parts.

Examples of use of the solution for preparing moulded articles and casted parts of films provided below.

### Compression Molding

Parts or films of different thicknesses may be prepared using compression molding at temperatures 20-50° C. above softening point.

First, powdered poly(amic acid) oligomers, obtained by removing the solvent from the solution comprising oligo- or poly(amic acid) comprising PEPA and EBPA residues, are placed in a mold which is pre-heated to allow the oligomer to become molten and, subsequently, the mold is closed. A pressure is applied to the mold assembly and the temperature of the press is ramped to the desired cure temperature, e.g. 380-400° C., and held there for 1 hour to cure the polyimide. Following cure, the temperature is gradually decreased to room temperature before removing the sample mold from the press.

### Casting from a Solvent

Parts of films may be prepared by solutions casting of the oligo- or poly(amic acid) prepared in solvents consisting of either NMP or in NMP/o-DMB. Prior to casting, the solutions may be filtered to remove particles. The solution is heated to 85° C. and the solvent is allowed to evaporate. Once solid to the touch, vacuum is applied for 12 hours followed by a gradual increase in temperature from 85-200° C. over an 8 hour period under vacuum. Finally, to ensure complete dryness, the final temperature is raised to 10° C. above the Tg of the oligomer. Following drying, the product may be cured in a furnace under nitrogen at the desired cure temperature, e.g. 380-400° C., and held there for 1 hour to provide a cross-linked material.

### Example 1

In order to obtain 200 grams of polyimide resin comprising EPBA and PEPA residues, EBPA (2 mol), 6FDA (Hexafluoro Bis Anhydride; 2 mol), pPDA (para phenylene diamine; 5 mol), and PEPA (2 mol) were mixed in methanol (400 g) in a 4L glass reactor. The resulting mixture was heated to reflux and stirred for a total of 2 hrs. The solution was then transferred to an aluminum pan and heated at a rate of 2.5° C./min until a temperature of 204° C. was reached. Thereafter the heating was continued at 0.05° C./min until a temperature of 232° C. was reached to produce a brittle solid powder. The staged, brittle solid powder was ground and molded into 3″×3″ (7.6 cm×7.6 cm) plates at 371° C. for 3 hrs under full vacuum. Those plates were then post cured in air at 371° C. for 8 hrs.

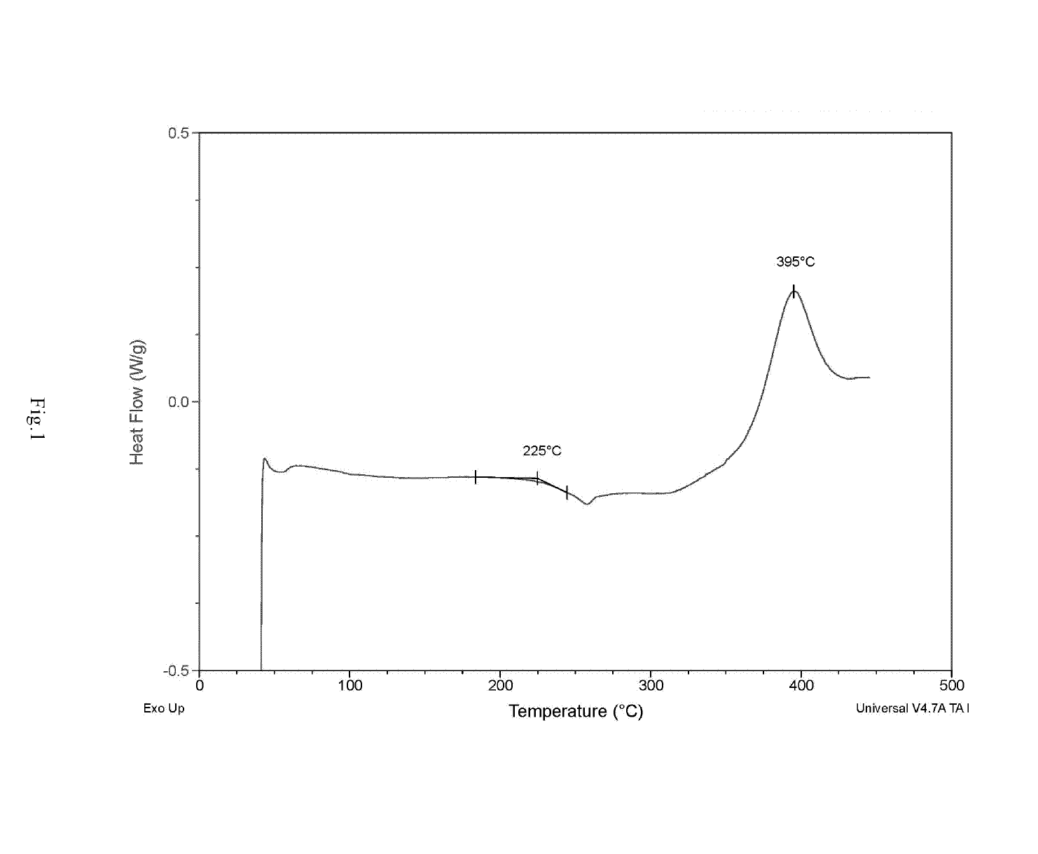

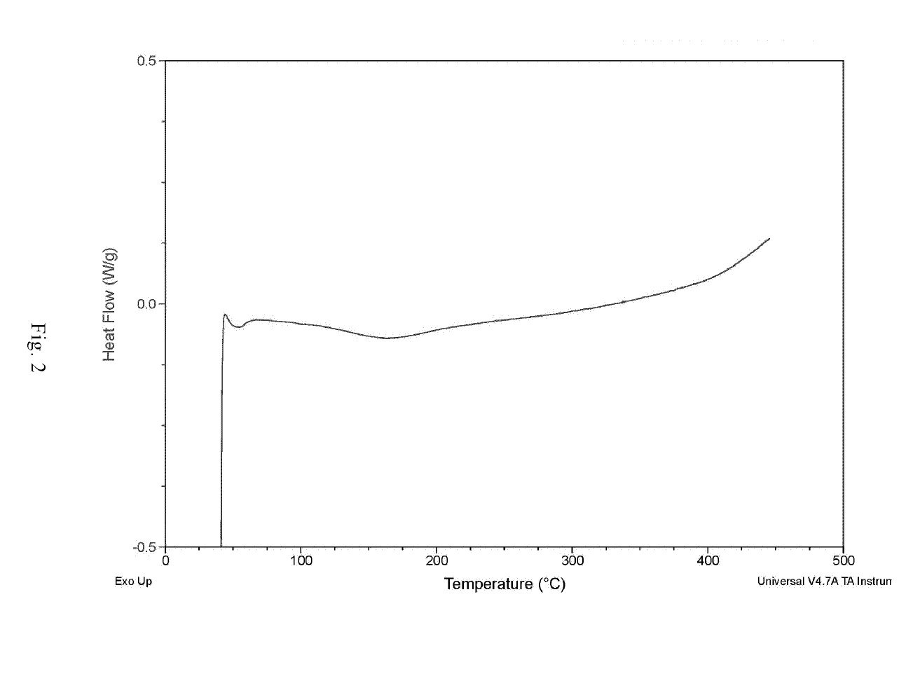

DSC was performed on the powders after staging (cf. FIG. 1) and cure (cf. FIG. 2), respectively. Further, RDA (Rheological Dynamic Analysis) performed on the plates after cure.

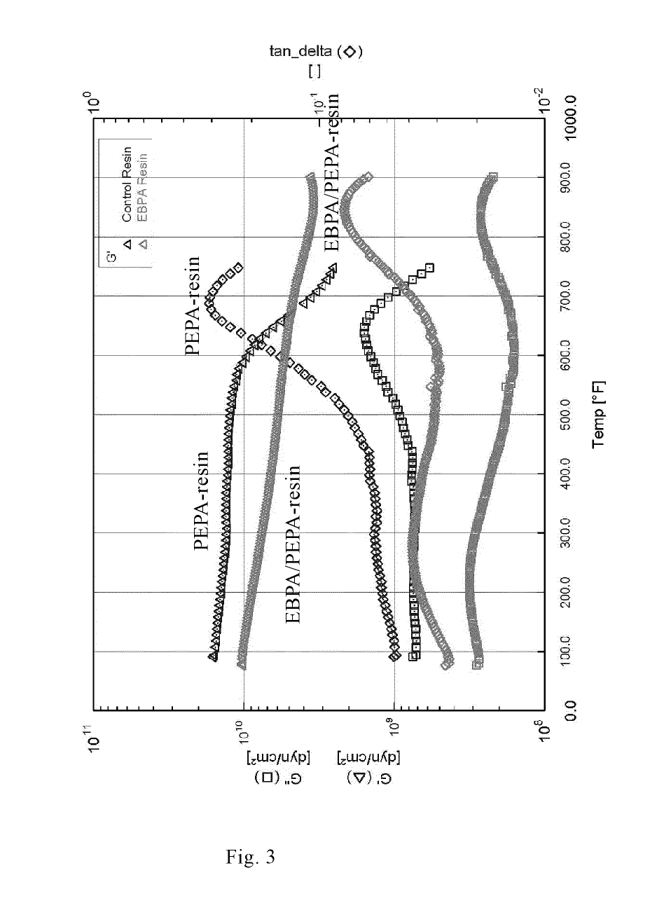

As can been seen from FIG. 1, the glass transition temperature of the uncured powder is about 225° C. Further, the uncured powder has an exoterm at about 395° C., corresponding to curing of the resin. The corresponding exoterm for a PEPA-resin is about 35 degrees lower. Hence, FIG. 1 confirms that also EBPA-residues are cross-linked. As indicated below (cf. FIG. 3), also the material data for the cures plates confirm that the presence of EBPA-residues provides resins with improved properties. Further, no corresponding exoterm is seen for the cured powder (cf. FIG. 2).

The RDA (cf. FIG. 3) shows that the incorporation of EBPA residues into a polyimide and subsequent curing provides a polyimide resin with significantly improved properties. While the peak of Tan delta is at about 690° F. (365° C.) for a PEPA-resin, the peak is almost at 850° F. (455° C.) for the corresponding EBPA/PEPA-resin. Further, G′(Δ) is linear for the EBPA/PEPA-resin up to temperatures exceeding 800° F. (427° C.), while only to about 575° F. (302° C.) for PEPA-resin. Thus, the EBPA/PEPA-resin may be used at higher temperatures than a corresponding PEPA-resin.

Especially promising is the indication of increased glass temperature (T_{g}), which implies that the wet T_{g} is increased as well. This will enable increased thermal resistance in humid environment, such as in aerospace applications. Further potential is increased durability in applications, such as friction wear and applications exposed for high temperatures where long service life is needed.

1. An oligo- or polyimide comprising:
one or two residue(s) of an anhydride based acetylenic end-capper;
at least one 5,5′-(ethyne-1,2-diyl)bis(isobenzofuran-1,3-dione) residue or least one 4,4′-(ethyne-1,2-diyl)bis(isobenzofuran-1,3-dione) residue;
at least one residue of an aromatic di-amine; and
at least one residue of an aromatic non-acetylenic di-anhydride.

2. The oligo- or polyimide according to claim 1, wherein said anhydride based acetylenic end-capper is an anhydride according to formula (V) 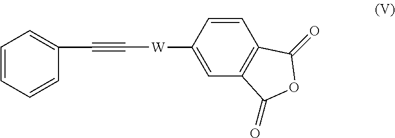
wherein W is a radical selected from the group consisting of 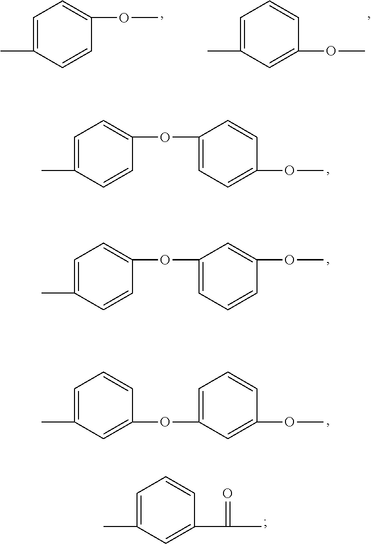
an anhydride according to formula (VV) 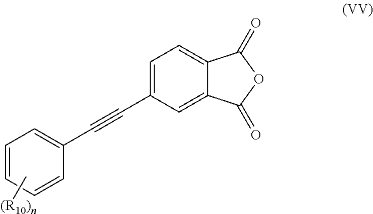
wherein
“n” is an integer of 1 to 5; and
R₁₀ is, independently of each other if the integer “n”>1, selected from the group consisting of halogen, nitro, aryl, benzyl, phenoxy, C1-4 alkyl, cyano, trifluoromethyl, and benzoyl; or
an anhydride selected from the group consisting of 5-(phenylethynyl)isobenzofuran-1,3-dione (PEPA), 5-ethynylisobenzofuran-1,3-dione (EPA), 5-(3-phenylpropioloyl)isobenzofuran-1,3-dione (PETA) and 5-(prop-1-yn-1-yl)isobenzofuran-1,3-dione (MEPA).

3. (canceled)

4. The oligo- or polyimide according to claim 2, wherein said anhydride based acetylenic end-capper is 5-phenylethynyl)isobenzofuran-1,3-dione (PEPA).

5. (canceled)

6. (canceled)

7. The oligo- or polyimide according to claim 1, wherein said aromatic non-acetylenic di-anydride is pyromellitic dianhydride or a dianhydride according to the general formula (II) 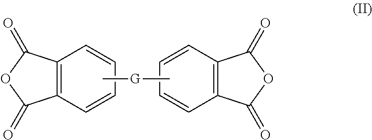
wherein G represents a direct bond or a di-valent group selected from the group consisting of a carbonyl group, a methylene group, a sulfone group, a sulfide group, an ether group, a —C(O)-phenylene-C(O)— group, an isopropylidene group, a hexafluoroisopropylidene group, a 3-oxyphenoxy group, a 4-oxyphenoxy group, a 4′-oxy-4-biphenoxy group, and a 4-[1-(4-oxyphenyl)-1-methylethyl]phenoxy group; and
wherein said aromatic di-amine is selected from the group 1,4-diaminobenzene, 1,3-diaminobenzene and di-amines according to general formula (I) 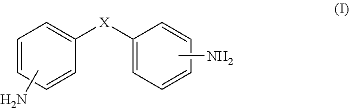
wherein
the amino groups may be connected to any carbon atom in the respective benzene residue; and
X is a direct bond or a moiety selected from the group consisting of —O—, —S—, —C(O)—, —C(CH₃)₂—, —C(CF₃)₂—, —CH₂—, 3-oxyphenoxy group, 4-oxyphenoxy group, 4′-oxy-4-biphenoxy group, and a 4-[1-(4-oxyphenyl)-1-methylethyl]phenoxy group.

8. The oligo- or polyimide according to claim 1, wherein said aromatic non-acetylenic di-anydride is selected from the group consisting of pyromellitic di-anhydride, 4,4′-oxydiphthalic anhydride, 2,2-bis-[4-(3,4-dicarboxyphenoxy)phenyl]-propane di-anhydride, 3,3′,4,4′-benzophenonetetracarboxylic acid di-anhydride, 3,3′,4,4′-tetracarboxybiphenyl di-anhydride, 4,4′,5,5′-sulfonyldiphthalic anhydride, and 5,5′-(perfluoropropane-2,2-diyl)bis(isobenzofuran-1,3-dione);
wherein said aromatic di-amine is selected from the group consisting of 4,4′-oxydianiline, 1,4-diaminobenzene, 1,3-diaminobenzene, 1,3-bis-(4-aminophenoxy)benzene, 1,3-bis-(3-aminophenoxy)benzene, methylenedianiline, 4,4′-diaminodiphenyl sulfone and 3,4′-oxydianiline.

9. (canceled)

10. (canceled)

11. The oligo- or polyimide according to claim 1, wherein said oligo- or polyimide comprises:
one or two residue(s) of said anhydride based acetylenic end-capper;
at least one 5,5′-(ethyne-1,2-diyl)bis(isobenzofuran-1,3-dione) residue;
at least 1 but less than 20 residues of an aromatic di-amine; and
at least one residue of an aromatic non-acetylenic di-anhydride;
wherein the sum of the numbers of 5,5′-(ethyne-1,2-diyl)bis(isobenzofuran-1,3-dione) residues and residues of aromatic non-acetylenic di-anhydride is less than twenty.

12. The oligo- or polyimide according to claim 1, wherein said oligo- or polyimide comprises:
one or two residue(s) of said anhydride based acetylenic end-capper;
at least one 5,5′-(ethyne-1,2-diyl)bis(isobenzofuran-1,3-dione) residue;
at least 20 but less than 200 residues of an aromatic di-amine; and
at least one residue of an aromatic non-acetylenic di-anhydride;
wherein the sum of the numbers of 5,5′-(ethyne-1,2-diyl)bis(isobenzofuran-1,3-dione) residues and residues of aromatic non-acetylenic di-anhydrides is at least 20 but less than 200.

13. The oligo- or polyimide according to claim 1, wherein said oligo- or polyimide comprises:
one or two residue(s) of said anhydride based acetylenic end-capper
at least one 5,5′-(ethyne-1,2-diyl)bis(isobenzofuran-1,3-dione) residue;
at least 200 residues of an aromatic di-amine; and
at least one residue of an aromatic non-acetylenic di-anhydride, such as at least 100 residues of an aromatic non-acetylenic di-anhydride;
wherein the sum of the number of 5,5′-(ethyne-1,2-diyl)bis(isobenzofuran-1,3-dione) residues and residues of aromatic non-acetylenic di-anhydrides is at least 200.

14. The oligo- or polyimide according to claim 1, wherein the weight average molecular weight of said oligo- or polyimide is 2,500 to 7,500, if said oligo- or polyimide is an oligoimide, or 25,000 to 100,000, if said oligo- or polyimide is a polyimide.

15. A method of obtaining an oligo- or polyimide, comprising the steps of:
mixing an anhydride based acetylenic end-capper, 5,5′-(ethyne-1,2-diyl)bis(isobenzofuran-1,3-dione) or 4,4′-(ethyne-1,2-diyl)bis(isobenzofuran-1,3-dione), an aromatic di-amine, and an aromatic non-actetylenic di-anhydride, in a solvent;
allowing the mixed monomers to react for about 1 to 24 hours at a temperature of about 20° C. to 120° C. to obtain an oligo- or poly(amic acid) comprising residues of said anhydride based acetylenic end-capper and of 5,5′-(ethyne-1,2-diyl)bis(isobenzofuran-1,3-dione) or 4,4′-(ethyne-1,2-diyl)bis(isobenzofuran-1,3-dione); and
dehydrating the obtained oligo- or poly(amic acid) comprising residues of said anhydride based acetylenic end-capper and of 5,5′-(ethyne-1,2-diyl)bis(isobenzofuran-1,3-dione) or 4,4′-(ethyne-1,2-diyl)bis(isobenzofuran-1,3-dione) to obtain an oligo- or polyimide.

16. (canceled)

17. The method according to claim 15, wherein said dehydration is performed by heating the obtained oligo- or poly(amic acid) comprising residues of said anhydride based acetylenic end-capper and of 5,5′-(ethyne-1,2-diyl)bis(isobenzofuran-1,3-dione) or 4,4′-(ethyne-1 ,2-diyl)bis(isobenzofuran-1,3-dione).

18. (canceled)

19. (canceled)

20. The method according to claim 15, wherein said anhydride based acetylenic end-capper is an anhydride according to formula (V) 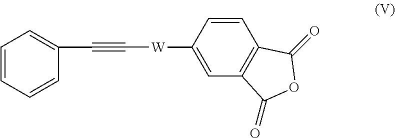
wherein W is a radical selected from the group consisting of 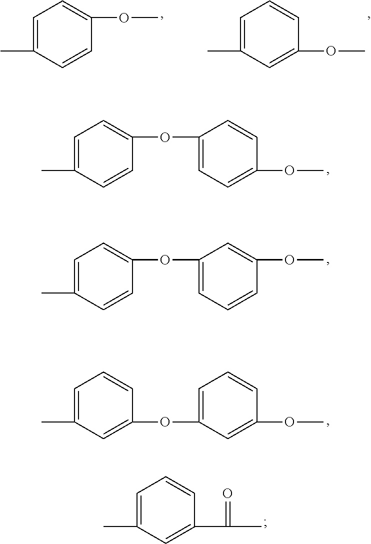
an anhydride according to formula (VV) 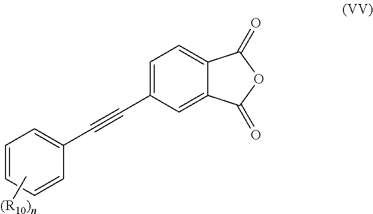
wherein
“n” is an integer of 1 to 5; and
R₁₀ is, independently of each other if the integer “n”>1, selected from the group consisting of halogen, nitro, aryl, benzyl, phenoxy, C1-4 alkyl, cyano, trifluoromethyl, and benzoyl; or
an anhydride selected from the group consisting of 5-(phenylethynyl)isobenzofuran-1,3-dione (PEPA), 5-ethynylisobenzofuran-1,3-dione (EPA), 5-(3-phenylpropioloyl)isobenzofuran-1,3-dione (PETA) and 5-(prop-1-yn-1-yl)isobenzofuran-1,3-dione (MEPA).

21. (canceled)

22. The method according to claim 20, wherein said anhydride based acetylenic end-capper is 5-(phenylethynyl)isobenzofuran-1,3-dione (PEPA).

23. The method according to claim 15, wherein said aromatic non-actetylenic di-anhydride is pyromellitic dianhydride or di-anhydride according to the general formula (II) 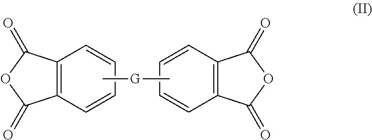
wherein G represents a direct bond or a di-valent group selected from the group consisting of a carbonyl group, a methylene group, a sulfone group, a sulfide group, an ether group, an —C(O)-phenylene-C(O)— group, an isopropylidene group, a hexafluoroisopropylidene group, a 3-oxyphenoxy group, a 4-oxyphenoxy group, a 4′-oxy-4-biphenoxy group, and a 4-[1-(4-oxyphenyl)-1-methylethyl]phenoxy group;
wherein said aromatic di-amine is selected from the group 1,4-diaminobenzene, 1,3-diaminobenzene and di-amines according to the general formula (I) 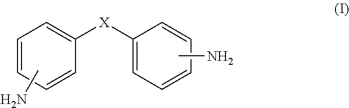
wherein
the amino groups may be connected to any carbon atoms in the respective benzene residue; and
X is a direct bond or a moiety selected from the group consisting of —O—, —S—, —C(O)—, —C(CH₃)₂—, —C(CF₃)₂—, —CH₂—, 3-oxyphenoxy group, 4-oxyphenoxy group, 4′-oxy-4-biphenoxy group, and 4-[1-(4-oxyphenyl)-1-methylethyl]phenoxy group.

24. The method according to claim 23, wherein said aromatic non-actetylenic di-anydride is selected from the group consisting of pyromellitic di-anhydride, 4,4′-oxydiphthalic anhydride, 2,2-bis-[4-(3,4-dicarboxyphenoxy)phenyl]-propane di-anhydride, 3,3′,4,4′-benzophenonetetracarboxylic acid di-anhydride, 3,3′,4,4′-tetracarboxybiphenyl di-anhydride, 4,4′,5,5′-sulfonyldiphthalic anhydride, and 5,5′-(perfluoropropane-2,2-diyl)bis(isobenzofuran-1,3-dione); and
wherein said aromatic di-amine is selected from the group consisting of 4,4′-oxydianiline, 1,4-diaminobenzene, 1,3-diaminobenzene, 1,3-bis-(4-aminophenoxy)benzene, 1,3-bis-(3-aminophenoxy)benzene, methylenedianiline, 4,4′-diaminodiphenyl sulfone and 3,4′-oxydianiline.

25. (canceled)

26. (canceled)

27. The method according to claim 15, wherein the relative molar amounts of said anhydride based acetylenic end-capper, 5,5′-(ethyne-1,2-diyl)bis(isobenzofuran-1,3-dione) (EBPA) or 4,4′-(ethyne-1,2-diyl)bis(isobenzofuran-1,3-dione), said aromatic di-amine, and said aromatic non-acetylenic di-anhydride, respectively, used to obtain said oligo- or polyimide are:
di-amine: 1.01 to 1.2;
di-anhydride: 0.1 to 0.9;
5,5′-(ethyne-1,2-diyl)bis(isobenzofuran-1,3-dione) or 4,4′-(ethyne-1,2-diyl)bis(isobenzofuran-1,3-dione): 0.1 to 0.9; and
anhydride based acetylenic end-capper: 0.01 to 0.3
with the proviso that the sum of the relative molar amount of di-anhydride and 5,5′-(ethyne-1,2-diyl)bis(isobenzofuran-1,3-dione) or 4,4′-(ethyne-1,2-diyl)bis(isobenzofuran-1,3-dione) equals 1.

28. An oligo- or polyimide obtainable by the method according to claim 15.

29. (canceled)

30. An article comprising:
an oligo- or polyimide according to claim 1.

31. The article according to claim 30, wherein said article is a flexible film for electronics, wire isolation, wire coating, wire enamel, ink, or a load-bearing
